(19) United States
(12) Patent Application Publication
(10) Pub. No.: US 2024/0327217 A1
(43) Pub. Date: Oct. 3, 2024

(54) PROCESS AND PRODUCING A SYNTHESIS GAS PRODUCT STREAM WITH REDUCED CARBON MONOXIDE EMISSION

(71) Applicant: L'Air Liquide, Societe Anonyme pour l'Etude et l’Exploitation des Procedes Georges Claude, Paris (FR)

(72) Inventors: Alexander ROESCH, Frankfurt am Main (DE); Mirko HUEBEL, Frankfurt am Main (DE); Maximilian HELMLE, Frankfurt am Main (DE)

(73) Assignee: L'Air Liquide, Societe Anonyme pour l'Etude et l’Exploitation des Procedes Georges Claude, Paris (FR)

(21) Appl. No.: 18/625,815

(22) Filed: Apr. 3, 2024

(30) Foreign Application Priority Data
Apr. 3, 2023 (EP) 23166297

(51) Int. Cl. C01B 3/38

(52) U.S. Cl. CPC C01B 3/384; C01B 2203/0233; C01B 2203/0261; C01B 2203/043; C01B 2203/0475; C01B 2203/0811; C01B 2203/1235

(57) ABSTRACT

The present invention proposes a process and a plant for producing a synthesis gas product stream by steam reforming of hydrocarbons, wherein the emission of carbon monoxide which is discharged to the environment together with a carbon dioxide-rich gas stream is reduced. According to the invention a first portion of the carbon monoxide-containing carbon dioxide-rich gas stream is introduced into the reformer furnace via at least one burner and/or into the reformer furnace outside the burners and at a location in the reformer furnace at which the local gas temperature is at least 1000° C. and/or into the flue gas conduit and/or into the flue gas chimney. A second portion of the carbon monoxide-containing carbon dioxide-rich gas stream is introduced into the reformer tubes.

### CROSS-REFERENCE TO RELATED APPLICATIONS

This application claims the benefit of priority under 35 U.S.C. § 119 (a) and (b) to EP patent application No. EP 23166297, filed Apr. 3, 2023, the entire contents of which are incorporated herein by reference.

### BACKGROUND

### Field of the Invention

The present invention relates to a process and a plant for producing a synthesis gas product stream by steam reforming of hydrocarbons, wherein the emission of carbon monoxide which is discharged to the environment together with a carbon dioxide-rich gas stream is reduced.

### Related Art

Hydrocarbons can be catalytically reacted with steam to give synthesis gas, i.e. mixtures of hydrogen (H₂) and carbon monoxide (CO). As is explained in Ullmann's Encyclopedia of Industrial Chemistry, Sixth Edition, 1998 Electronic Release, keyword “Gas Production”, so-called steam reforming is the most commonly employed method of producing synthesis gas which may then be converted into further important commodity chemicals such as methanol or ammonia. While different hydrocarbons, such as naphtha, liquid gas or refinery gases, can be converted, it is steam reforming of methane-containing natural gas that dominates.

After pre-heating by heat exchangers or fired heaters to a temperature above about 500° C., for example up to 650° C., the hydrocarbon-steam mixture, after final heating to about 800° C. to 950° C., enters the reformer tubes of the steam reformer heated by a multiplicity of burners and is therein converted into carbon monoxide and hydrogen over the reforming catalyst. Nickel-based reforming catalysts are in widespread use. While higher hydrocarbons are converted fully to carbon monoxide and hydrogen, partial conversion is typical in the case of methane. The composition of the product gas is determined by the reaction equilibrium; the product gas thus contains not only carbon monoxide and hydrogen but also carbon dioxide, unconverted methane and water vapour. For energy optimization or in the case of input materials comprising higher hydrocarbons, a so-called pre-reformer for pre-cracking of the input material may be employed downstream of the pre-heater. The pre-cracked input material is then heated to the desired reformer tube entry temperature in a further heater.

The hot raw synthesis gas product gas is partially cooled in indirect heat exchange against process media to be heated in one or more heat exchangers after leaving the reformer furnace. The partially cooled raw synthesis gas product gas then undergoes further conditioning steps dependent on the type of the desired product or the downstream process. If the synthesis gas production is primarily directed to the generation of pure hydrogen, the hydrogen content in the synthesis gas produced is increased by the application of CO conversion, also referred to as water-gas shift reaction (WGS) or CO shift reaction.

The further treatment of the raw synthesis gas often also comprises a process for separating the carbon dioxide, for example by physical or chemical absorption or gas scrubbing. Such processes are also referred to as carbon capture (CC) processes. A known and frequently employed process for carbon dioxide removal is the Rectisol process, which comprises a scrubbing of the raw synthesis gas with cryogenic methanol as absorbent and is likewise described in principle in the abovementioned literature. Other scrubbing processes employ other scrubbing or absorption media, for example N-methylpyrrolidone (NMP), secondary amines, for example diethanolamine, tertiary amines, for example methyldiethanolamine (MDEA), polyethylene glycol dialkyl ethers, for example polyethylene glycol dimethyl ether. The specific process conditions to be employed here, the selection of which is familiar to those skilled in the art, are referred to hereinafter as carbon dioxide removal conditions.

By contrast, in a steam reforming process which is focused especially or exclusively on the production of pure hydrogen or on the production of the synthesis gas products carbon monoxide and hydrogen, the separated carbon dioxide is often released into the atmosphere. The separated carbon dioxide is obtained as a rich gas stream in the regeneration of the employed scrubbing or absorption medium.

It is problematic that the separated carbon dioxide recovered by regeneration still contains a certain proportion of carbon monoxide (CO). The carbon monoxide is co-absorbed in the solvent in the absorption step and

also discharged into the carbon dioxide-rich gas stream in the regeneration step. The allowable emission threshold for CO is thus often exceeded when the carbon dioxide-rich gas stream is discharged into the atmosphere. For example according to Directive 2010/75/EU of the European Parliament and of the Council of 24 Nov. 2010 on industrial emissions the emission threshold for CO is:
a) 50 mg/Nₘ³ as a daily average;
b) 100 mg/Nₘ³ as a half-hourly average;
c) 150 mg/Nₘ³ as a ten-minute average.

One possible solution is therefore that of providing an additional flash stage between the absorption step and the regeneration step. A large part of the CO is separated before the actual regeneration step by simple decompressing and may be added to the fuel gas for the reformer burners for example. This makes it possible to observe the emission threshold for CO. However, the considerable additional capital costs for installation of the flash stage are disadvantageous.

### SUMMARY OF THE INVENTION

It is accordingly an object of the present invention to provide a process and a plant for producing a synthesis gas product stream by steam reforming of hydrocarbons where the emission of carbon monoxide which is discharged to the environment together with a carbon dioxide-rich gas stream is reduced.

This object is achieved in a first aspect by a process having the features of claim 1 and in a further aspect by a plant having the features of claim 9. Further embodiments of the invention are apparent from the subsidiary claims of the respective category.

The steam reforming conditions and CO conversion conditions are known to those skilled in the art from the prior art, for example the documents discussed at the outset. These are the physicochemical conditions under which a measurable, preferably industrially relevant, conversion of hydrocarbons to synthesis gas products (steam reforming) or of carbon monoxide and steam to carbon dioxide and hydrogen according to the conversion equation shown above is achieved. Necessary adjustments of these conditions to the particular operating requirements, for example with regard to the reactant volume flow rates, pressures, reaction temperatures, especially the steam reforming inlet temperature, nature and amount of catalysts used, will be undertaken on the basis of routine tests. Any specific reaction conditions disclosed may serve here as a guide, but they should not be regarded as limiting in relation to the scope of the invention.

A physical or chemical carbon dioxide separation process in the context of the present disclosure is understood to mean a process that enables separation of a fluid mixture, for example a gas mixture, into its constituents by employment of suitable physicochemical conditions, for example by phase conversion such as condensation or by use of a suitable sorbent, or removal of unwanted components from said mixture. If a sorption process is employed, this may be based on an adsorption, i.e. binding of the substance(s) to be removed to a surface or interface of the solid absorbent, or on an absorption, i.e. uptake of the substance(s) to be removed into the volume of the liquid or solid absorbent. The substance(s) removed and bound by sorption are referred to as adsorbate/absorbate. The binding forces acting here may be physical or chemical by nature. Accordingly, physical sorption results from usually relatively weak, less specific bonding forces, for example van der Waals forces, whereas chemical sorption results from relatively strong, more specific bonding forces, and the adsorbate/absorbate and/or the adsorbent/absorbent are chemically altered.

Synonyms used for the term “absorbent” in the context of this disclosure are the terms “absorption medium” or “scrubbing medium” in the case of liquid absorbents.

One specific, physical absorption process is gas scrubbing with cryogenic methanol, which uses as absorbent or scrubbing medium methanol having a temperature cooled by means of refrigerating processes to below ambient temperature, preferably below 0° C., most preferably below −30° C. This process is known to those skilled in the art as the Rectisol process.

By contrast, the amine scrubbing operations that are known per se and are frequently used for absorption of carbon dioxide are based on chemical absorption (chemisorption) and attain high purities in the absorption column even at relatively low pressures. Selectivity is likewise usually higher than in physical absorption processes.

In amine scrubbing, slightly alkaline aqueous solutions of amines, frequently ethanolamine derivatives, are used in an absorption unit (absorption section) which is usually configured as a scrubbing column. Absorption is effected at low temperature, for example 40° C., and slightly elevated pressure, for example 8 bara. Fresh or regenerated absorbent is applied at the top of the column and the gas stream to be separated is introduced in the lower region of the scrubbing column. This causes carbon dioxide to be reversibly chemically absorbed. The carbon dioxide-depleted gas exits the column at the top, and the laden scrubbing medium is discharged at the bottom of the column and passed into a desorption section which is likewise often configured as a separating column. In the desorption column (regeneration section) higher temperature and lower pressure are used to reverse the chemical equilibrium of the reaction, with the result that the absorbed carbon dioxide is released in gaseous form. It may then be discharged at the top of the desorption column and sent for further utilization or disposal. The absorbent regenerated in this way is recycled to the absorption section.

An absorbent frequently used in amine scrubbing is methyldiethanolamine (MDEA), which is usually used in aqueous solutions. Often also added are activators, for example piperazine, to accelerate the carbon dioxide absorption, as described for example in the article “The Activator Mechanism of Piperazine in Aqueous Methyldiethanolamine Solutions” J. Ying et al., Energy Procedia 114 (2017), pp. 2078-2087. These mixtures are then referred to as activated MDEA solutions (aMDEA).

A fluid connection between two regions of the apparatus according to the invention is understood to mean any type of connection which makes it possible for a fluid, for example a gas stream, to flow from one to the other of the two regions, irrespective of any interposed regions or components. In particular, a direct fluid connection is understood to mean any type of connection which makes it possible for a fluid, for example a gas stream, to flow directly from one to the other of the two regions, wherein no further regions or components are interposed, with the exception of purely transportational operations and the means required therefor, for example pipelines, valves, pumps, compressors, reservoirs. One example would be a pipe conduit leading directly from one to the other of the two regions.

A means is understood to mean an article which makes it possible to achieve, or is helpful in achieving, an objective. In particular, means of performing a particular process step are understood to mean all those physical articles which those skilled in the art would consider in order to be able to perform this process step. For example, those skilled in the art will consider means of introducing or discharging a stream to include all transporting and conveying apparatuses, i.e., for example, pipelines, pumps, compressors, valves, which seem necessary or sensible for the performance of that process step on the basis of their knowledge in the art.

All pressures are reported in absolute pressure units, bara or bar (a) for short, or in gauge pressure units, barg or bar (g) for short, unless stated otherwise in the particular individual context.

For the purposes of this description, steam is to be understood as being synonymous with water vapour unless otherwise stated in an individual case.

The invention is based on the finding that it is not necessary to subject the entire carbon dioxide-rich gas stream to a purification step in order to reliably remain under the predetermined emission threshold for carbon monoxide from the reformer plant. On the contrary, according to the invention the carbon dioxide-rich gas stream is divided into a first and a second portion. The first portion of the carbon dioxide-rich gas stream is alternatively introduced into one or more of the following places:
into the reformer furnace via at least one burner and/or
into the reformer furnace outside the burners and at a location in the reformer furnace at which the local gas temperature is at least 1000° C. and/or
into the flue gas conduit and/or
into the flue gas chimney.

According to the invention the second portion of the carbon monoxide-containing carbon dioxide-rich gas stream is introduced into the reformer tubes.

This ensures that the carbon monoxide content in the first portion of the carbon dioxide-rich gas stream is efficiently reduced by oxidation/post-combustion. The resulting offgas stream is discharged from the process and released to the environment together with the flue gas stream or as a portion of the flue gas stream. The carbon monoxide content in the second portion of the carbon dioxide-rich gas stream is reduced because a portion of the CO present passes into the synthesis gas product stream and is thus materially utilized.

### PREFERRED EMBODIMENTS OF THE INVENTION

A second aspect of the process according to the invention is characterized in that in the case of the alternative (i1) of claim 1 a feeding and distribution system for the carbon monoxide-containing carbon dioxide-rich gas stream which is separate from the operating gases of the burners and may be switched on or off or controlled separately is provided. This allows the burner operation to be disrupted as little as possible since the fuel gas stream and the portion of the carbon dioxide-rich gas stream recycled to the burners may be controlled separately from one another.

A third aspect of the process according to the invention is characterized in that in the case of the alternatives (i3) or (i4) of claim 1 a catalyst zone is provided in the flue gas conduit and/or in the flue gas chimney, wherein the catalyst zone contains a catalyst active for the catalytic oxidation of carbon monoxide with oxygen to afford carbon dioxide. Since the flue gas temperature is lower at these introduction points than in the burners, the catalytic oxidation can be used to efficiently reduce the concentration of carbon monoxide.

A fourth aspect of the process according to the invention is characterized in that the oxygen required for the catalytic oxidation of carbon monoxide is not separately introduced into the flue gas conduit or into the flue gas chimney but rather that exclusively the residual oxygen present in the flue gas stream is utilized as oxygen-containing oxidant. The residual oxygen content exceeds the CO concentration many times over and therefore this measure makes it possible to eschew dedicated feed conduits for oxygen as oxidant for catalytic oxidation of carbon monoxide.

A fifth aspect of the process according to the invention is characterized in that the catalyst zone contains at least one catalyst active for the catalytic oxidation of carbon monoxide with oxygen to afford carbon dioxide which is selected from the group consisting of:
catalyst beds composed of particulate catalysts, catalytic wire mesh, honeycomb catalysts, structured packing catalysts.

Due to the multiplicity of commercially available catalysts, the catalyst optimal for the respective usage location in terms of pressure drop and catalyst activity may be selected.

A sixth aspect of the process according to the invention is characterized in that the catalyst zone contains
(a) at least one catalyst active for the catalytic oxidation of carbon monoxide with oxygen to afford carbon dioxide which is also active for the selective catalytic reduction (SCR) of nitrogen oxides or
(b) at least one first catalyst active for the catalytic oxidation of carbon monoxide with oxygen to afford carbon dioxide and at least one second catalyst active for the selective catalytic reduction (SCR) of nitrogen oxides. Aspect (a) is particularly advantageous since no separate catalyst is thus required for the catalytic CO oxidation but rather the SCR catalyst present may be used. Commonly used SCR catalysts, for example based on vanadium pentoxide, also have an activity for catalytic CO oxidation.

A seventh aspect of the process according to the invention is characterized in that no separate flash stage for separating a carbon monoxide-containing flash gas from the carbon dioxide-enriched scrubbing medium stream is present in the flow path of the carbon dioxide-enriched scrubbing medium stream between the absorption column and the hot regeneration apparatus. Due to the inventive treatment of the carbon dioxide-depleted scrubbing medium stream, the separate flash stage can be eschewed, thus reducing the capital costs and the required space requirements for a corresponding plant.

An eighth aspect of the process according to the invention is characterized in that a third portion of the carbon monoxide-containing carbon dioxide-rich gas stream is discharged to the environment. In this way the operating reliability of the process and a corresponding plant is increased since in the case of outages in individual process steps a portion of the carbon dioxide-rich gas stream may be briefly discharged to the environment as an emergency measure.

A ninth aspect of the invention relates to the plant according to claim 9.

In a tenth aspect of the invention the plant is characterized in that in the case of the alternative (i1) in claim 9 it comprises a feeding and distribution system for the carbon monoxide-containing carbon dioxide-rich gas stream which is separate from the operating gases of the burners and may be switched on or off or controlled separately. The advantages obtained in this aspect of the invention correspond to those discussed in connection with the second aspect of the invention.

In an eleventh aspect of the invention the plant is characterized in that in the case of the alternatives (i3) or (i4) in claim 9 it comprises a catalyst zone in the flue gas conduit and/or in the flue gas chimney, wherein the catalyst zone contains a catalyst active for the catalytic oxidation of carbon monoxide with oxygen to afford carbon dioxide. The advantages obtained in this aspect of the invention correspond to those discussed in connection with the third aspect of the invention.

In a twelfth aspect of the invention the plant is characterized in that the catalyst zone contains at least one catalyst active for the catalytic oxidation of carbon monoxide with oxygen to afford carbon dioxide which is selected from the group consisting of:
catalyst beds composed of particulate catalysts, catalytic wire mesh, honeycomb catalysts, structured packing catalysts. The advantages obtained in this aspect of the invention correspond to those discussed in connection with the fifth aspect of the invention.

In a thirteenth aspect of the invention the plant is characterized in that the catalyst zone contains
(a) at least one catalyst active for the catalytic oxidation of carbon monoxide with oxygen to afford carbon dioxide which is also active for the selective catalytic reduction (SCR) of nitrogen oxides or
(b) at least one first catalyst active for the catalytic oxidation of carbon monoxide with oxygen to afford carbon dioxide and at least one second catalyst active for the selective catalytic reduction (SCR) of nitrogen oxides. The advantages obtained in this aspect of the invention correspond to those discussed in connection with the sixth aspect of the invention.

In a fourteenth aspect of the invention the plant is characterized in that no separate flash stage for separating a carbon monoxide-containing flash gas from the carbon dioxide-enriched scrubbing medium stream is present in the flow path of the carbon dioxide-enriched scrubbing medium stream between the absorption column and the hot regeneration apparatus. The advantages obtained in this aspect of the invention correspond to those discussed in connection with the seventh aspect of the invention.

### BRIEF DESCRIPTION OF THE FIGURES

Further developments, advantages and possible uses of the invention are also apparent from the description of working examples that follows and the drawings. The invention is formed by all of the features described and/or depicted, either on their own or in any combination, irrespective of the way they are combined in the claims or the dependency references therein.

In the figures:

FIG. 1 shows an example of a steam reforming process/a corresponding plant for producing a synthesis gas product stream according to the prior art where a carbon monoxide-containing carbon dioxide-rich gas stream is discharged to the atmosphere;

FIG. 2 shows an example of a steam reforming process/a corresponding plant for producing a synthesis gas product stream according to the prior art where CO emission is reduced by a flash stage arranged between the absorption step and the desorption step;

FIG. 3 shows an example of a steam reforming process/a corresponding plant for producing a synthesis gas product stream where CO emission is reduced according to a first embodiment of the invention;

FIG. 4 shows an example of a steam reforming process/a corresponding plant for producing a synthesis gas product stream where CO emission is reduced according to a second embodiment of the invention;

FIG. 5 shows an example of a steam reforming process/a corresponding plant for producing a synthesis gas product stream where CO emission is reduced according to a third embodiment of the invention.

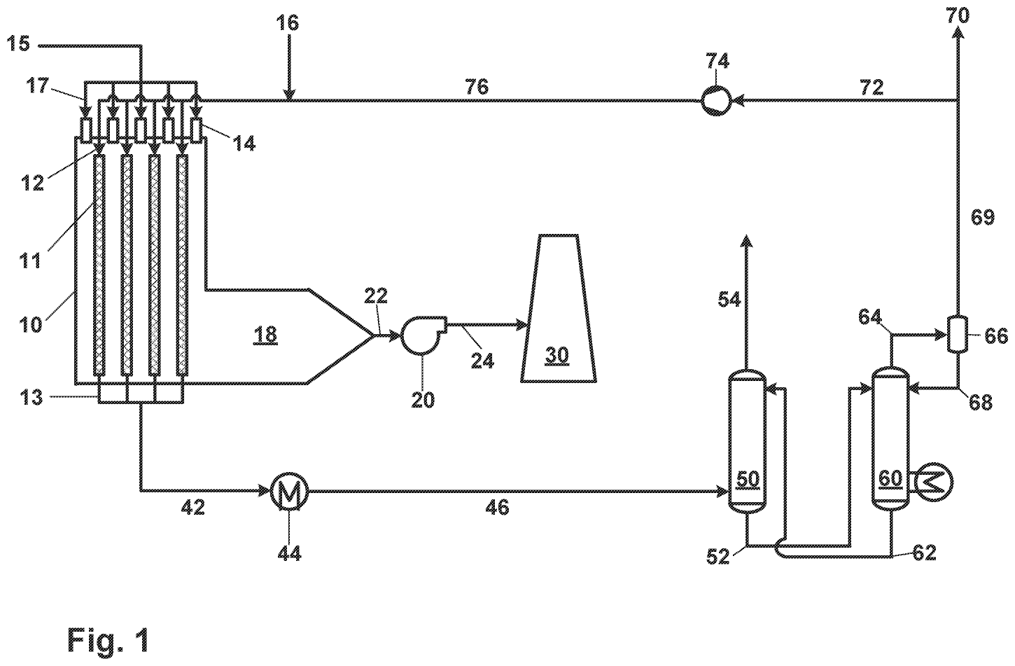

FIG. 1 shows an example of a steam reforming process/a corresponding plant for producing a synthesis gas product stream according to the prior art where CO emission is reduced by a flash stage arranged between the absorption step and the desorption step.

### DETAILED DESCRIPTION OF THE INVENTION

In FIG. 1, the reformer furnace 10 contains a multiplicity of catalyst-filled reformer tubes 11. The number of reformer tubes is typically several hundred; for clarity the figure shows only four reformer tubes. The employed catalyst is a nickel-based, commercially available steam reforming catalyst. The reformer tubes are supplied with pre-heated, hydrocarbon-containing natural gas as reformer input via conduits 16, 76 and 12. The entry temperature of the reformer input is for example 500° C. Before entry of the reformer input into the reformer, said input is admixed with steam (not shown in the figure) to give a defined steam/carbon ratio of for example 3 mol/mol. After conversion of the input in the reformer tubes, the gaseous reformer product containing hydrogen, CO and unconverted natural gas constituents is withdrawn via conduits 138 and 42 and cooled in heat exchanger 44 to obtain a cooled raw synthesis gas as reformer product which is discharged via conduit 46.

The reformer tubes are fired using a multiplicity of burners 14 which are attached to the top of the reformer furnace and fire the interspace between the reformer tubes. For clarity the figure shows only five burners. In the example of FIG. 1 the burners 14 are operated with natural gas and/or flammable gases from the synthesis gas workup as fuel gas. The fuel gas is supplied to the burners via conduit 15 and distribution conduits 17. In addition, pre-heated combustion air is admixed with the fuel gas and/or introduced into the burners 14 (not shown).

In the reformer furnace 10, heat is transferred to the reformer tubes by thermal radiation from the burner flames and by convective heat transfer from the hot flue gases. Once heat transfer is complete, the flue gases enter the waste heat portion 18 of the reformer furnace 10. Conveying of the flue gases through the waste heat portion of the reformer furnace is effected via conduit 22 in the extraction draught of the blower 20. The waste heat portion of the reformer furnace further cools the flue gases via a plurality of heat exchangers in the flue gas path with utilization of the enthalpy of the flue gases for pre-heating two or more input streams, for example the reformer input and the combustion air (not shown). The cooled flue gases are then supplied to the flue gas chimney 30 via conduit 24 and discharged into the atmosphere thereby.

The cooled raw synthesis gas is supplied via conduit 46 to an absorption column 50 and introduced thereto. If maximizing the hydrogen yield is the primary process objective the hydrogen content in the raw synthesis gas is optionally increased (not shown) before introduction into the absorption column by performing CO conversion (water gas shift (WGS) reaction) using added steam over a suitable catalyst according to the reaction equation CO+H₂O=H₂+CO₂. This reduces the content of carbon monoxide in the raw synthesis gas and increases the content of carbon dioxide according to the stoichiometry of the WGS reaction.

Performance of the gas scrubbing in the absorption column 50 is carried out in a manner known per se by contacting the raw synthesis gas with a CO₂-selective scrubbing medium/absorbent, for example an amine-containing scrubbing medium, in one example with a scrubbing medium containing methyldiethanolamine (MDEA). Via conduit 54 a carbon dioxide-depleted synthesis gas product stream is discharged from the absorption column 50 and sent for further purification, conditioning or use.

The carbon dioxide-laden scrubbing medium is discharged from the absorption column 50 and introduced into the regeneration apparatus 60 via conduit 52. The regeneration apparatus 60 effects regeneration of the scrubbing medium by pressure reduction (flashing) and hot regeneration by stripping with intrinsic vapour. A regenerated scrubbing medium stream is discharged from the regeneration apparatus 60 via conduit 62 and after optional cooling and compression (both not shown) introduced into the absorption column 50.

A carbon dioxide-rich gas stream still containing a significant proportion of carbon monoxide is discharged from the regeneration apparatus 60 via conduit 64 and introduced into a gas-liquid phase separator 66. In the gas-liquid phase separator 66, liquid proportions of the scrubbing medium that still remain in the carbon dioxide-rich gas stream are separated and recycled into the regeneration apparatus 60 via conduit 68.

The carbon dioxide-rich gas stream still containing a significant proportion of carbon monoxide is discharged from the gas-liquid phase separator 66 via conduit 69. A first portion of the carbon monoxide-containing carbon dioxide-rich gas stream is discharged to the atmosphere via conduit 70. A second portion of the carbon monoxide-containing carbon dioxide-rich gas stream is recycled via conduit 72, compressor 74 and conduits 76 and 12 to the reformer tubes 11, partially converted into carbon monoxide therein and thus materially utilized.

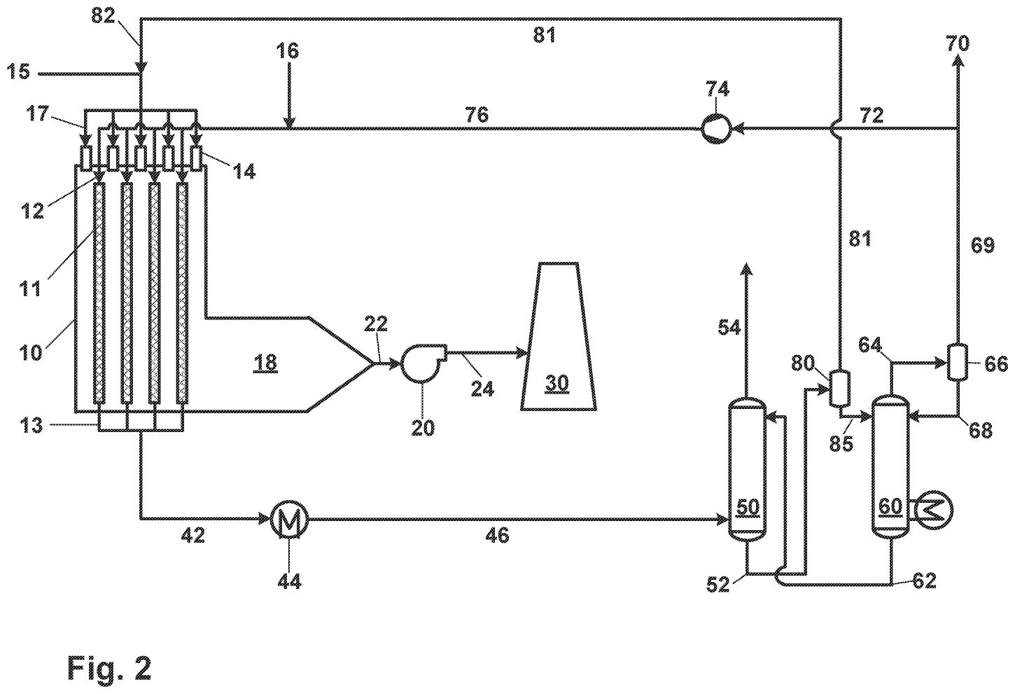

Discharging the first portion of the carbon monoxide-containing carbon dioxide-rich gas stream to the atmosphere is always problematic if the CO concentration thereof exceeds the allowable emission threshold for carbon monoxide. Such a case is therefore shown in FIG. 2.

In FIGS. 2 to 5, elements with identical reference symbols correspond to the elements, and the use, function and properties thereof, previously elucidated in connection with FIG. 1.

In contrast to FIG. 1, FIG. 2 has a flash stage 80 arranged between the absorption column 50 and the regeneration apparatus 60. The carbon dioxide-laden scrubbing medium is discharged from the absorption column 50 and introduced into the flash stage 80 via conduit 52. As a result of the sudden decompression, the flash stage affords a gas phase containing the predominant proportion of the carbon monoxide that was previously dissolved in the carbon dioxide-laden scrubbing medium. The carbon monoxide-depleted, carbon dioxide-laden scrubbing medium is discharged from the flash stage 80 and introduced into the regeneration apparatus 60 via conduit 85.

The carbon monoxide-containing gas phase is discharged from the flash stage 80 via conduit 81 and via conduits 82 and 15 recycled to the burners 14 where it is reacted together with fuel gas and combustion air. This achieves a reduction in the CO content through thermal post-oxidation. The resulting flue gases are discharged to the atmosphere as elucidated in connection with FIG. 1.

Disadvantages of the process mode shown in FIG. 2 include the additional capital costs and the additional space requirements for the flash stage. It is therefore an object of the present invention to eschew such a flash stage but simultaneously reduce the CO emission to the atmosphere.

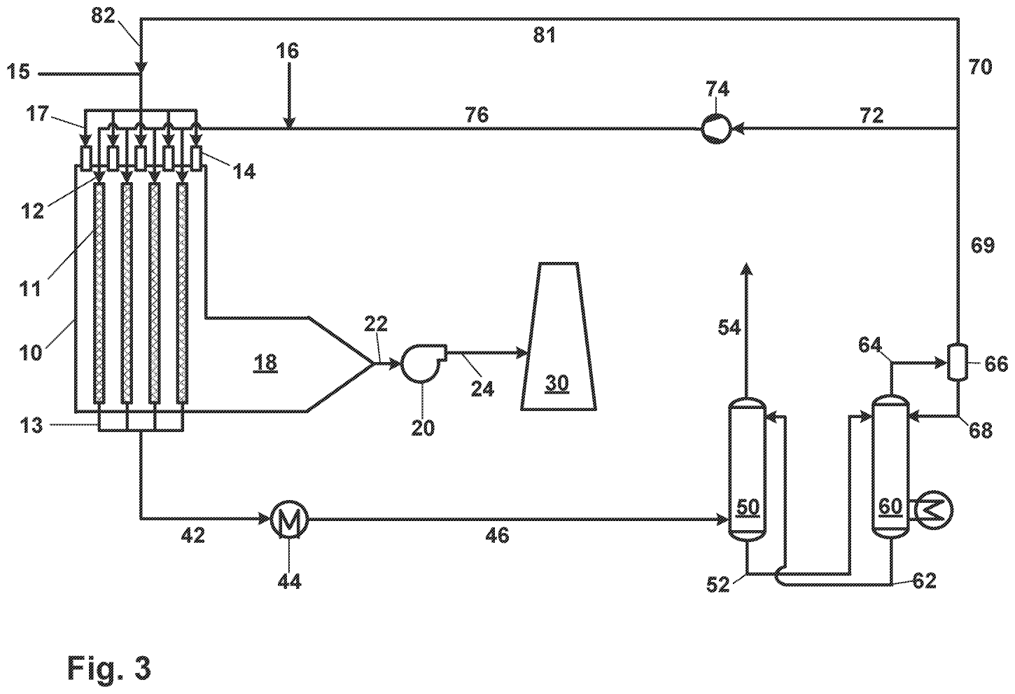

Thus, according to FIG. 3 which shows a first embodiment of the invention, the first portion of the carbon monoxide-containing carbon dioxide-rich gas stream is not discharged to the atmosphere via conduit 70 but rather recycled via conduits 70, 81 and 82 to the burners 14 where it is reacted together with fuel gas and combustion air. This achieves a reduction in the CO content through thermal post-oxidation. The resulting flue gases are discharged to the atmosphere as elucidated in connection with FIG. 1. The first portion of the carbon monoxide-containing carbon dioxide-rich gas stream may be introduced into the conduit 15 for example or in a further example be introduced into the burners via a separate feeding and distribution system (so-called header). The latter procedure is advantageous since the supplying of the burners with fuel gas and combustion air on the one hand and with the first portion of the carbon monoxide-containing carbon dioxide-rich gas stream on the other hand is carried out independently. This allows trouble-free burner operation and good and independent controllability of the gas streams.

Just as in FIG. 1 the second portion of the carbon monoxide-containing carbon dioxide-rich gas stream is recycled via conduit 72, compressor 74 and conduits 76 and 12 to the reformer tubes 11, partially converted into carbon monoxide therein and thus materially utilized.

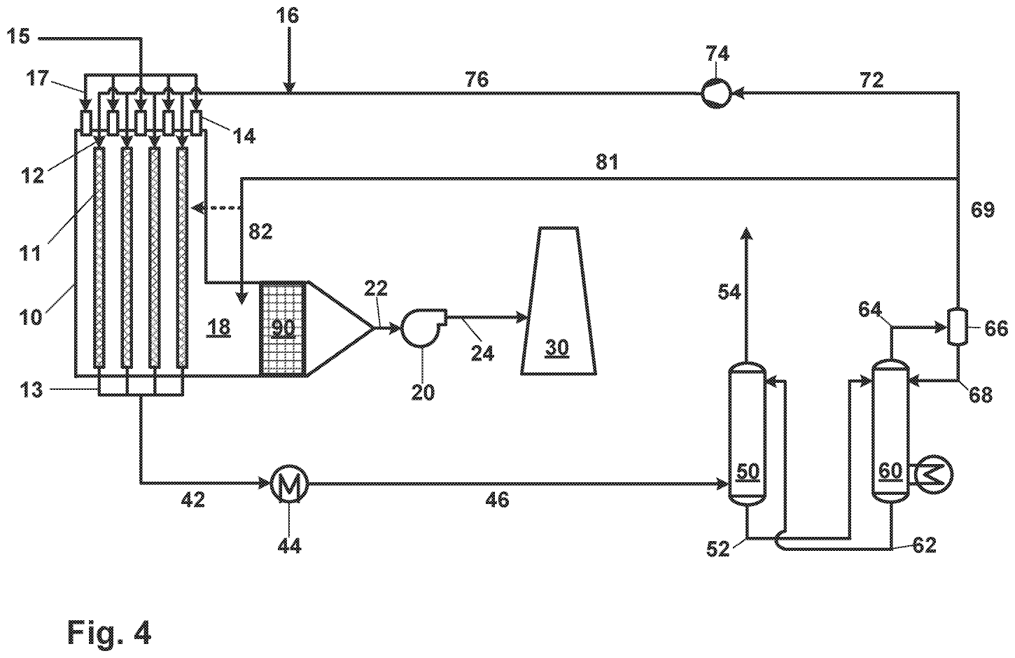

In a second embodiment of the invention, according to FIG. 4 the first portion of the carbon dioxide-rich gas stream present is not discharged to the atmosphere but rather recycled to the reformer furnace and introduced thereto via conduits 81 and 82. The introducing may be effected into the reformer furnace 10 (indicated by dashed arrow) and/or into the waste heat portion 18 in fluid connection therewith (conduit 82, solid arrow). Introduction into the hot portion of the reformer furnace results in a spontaneous post-combustion of the carbon monoxide. In the case of introduction into the waste heat portion 18, an oxidation catalyst 90 which catalyses the CO oxidation into carbon dioxide may optionally be provided. It is particularly advantageous for the co-oxidation to utilize an already present catalyst for selective catalytic reduction (SCR) of nitrogen oxides in the reforming flue gas.

Just as in FIG. 1 the second portion of the carbon monoxide-containing carbon dioxide-rich gas stream is recycled via conduit 72, compressor 74 and conduits 76 and 12 to the reformer tubes 11, partially converted into carbon monoxide therein and thus materially utilized.

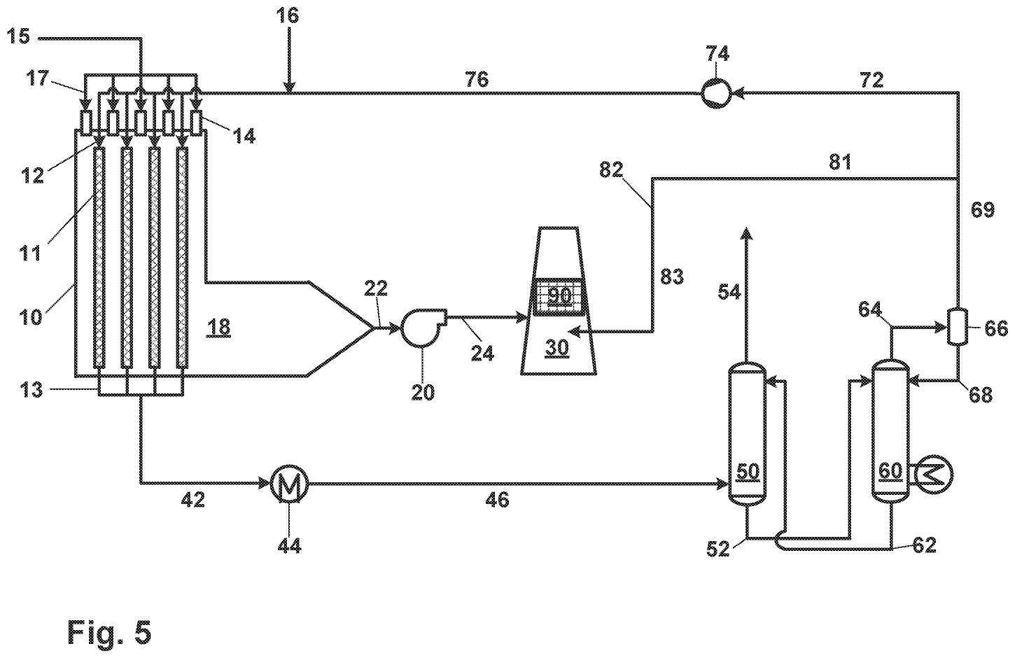

In a third embodiment of the invention, according to FIG. 5 the first portion of the carbon dioxide-rich gas stream present is not discharged to the atmosphere but rather passed to the flue gas chimney 30 and introduced thereto via conduits 81, 82 and 83. Since the temperature of the reforming flue gas in the flue gas chimney has already been markedly reduced it is generally necessary to provide an oxidation catalyst 90 which catalyses the CO oxidation to afford carbon dioxide.

Just as in FIG. 1 the second portion of the carbon monoxide-containing carbon dioxide-rich gas stream is recycled via conduit 72, compressor 74 and conduits 76 and 12 to the reformer tubes 11, partially converted into carbon monoxide therein and thus materially utilized.

In the exemplary embodiments of the invention according to FIG. 3, 4 or 5 it is particularly advantageous when the oxygen required for the catalytic oxidation of carbon monoxide is not separately introduced into the flue gas conduit or into the flue gas chimney but rather that exclusively the residual oxygen present in the flue gas stream is utilized as oxygen-containing oxidant. The residual oxygen content in the flue gas stream exceeds the CO concentration many times over and therefore this measure makes it possible to eschew dedicated feed conduits for oxygen as oxidant for catalytic oxidation of carbon monoxide.

Changes to the above-described embodiments of the present disclosure are possible without departing from the scope of the present disclosure defined by the accompanying claims. Expressions such as “including”, “comprising”, “containing”, “have”, “is” which are used for describing and claiming the present disclosure shall be understood to be nonexhaustive, i.e. they allow for the presence of articles, components or elements that are not explicitly described. References to the singular are to be understood as also referring to the plural in the absence of explicit indications to the contrary in the particular case.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

### LIST OF REFERENCE SYMBOLS

[10] Reformer furnace
[11] Reformer tubes
[12] Conduit
[13] Conduit
[14] Burner
[15] Conduit
[16] Conduit
[17] Conduit
[18] Waste heat portion of reformer furnace
[20] Flue gas blower
[22] Conduit
[24] Conduit
[30] Flue gas chimney
[42] Conduit
[44] Heat exchanger
[46] Conduit
[50] Absorption column
[52] Conduit
[54] Conduit
[60] Regeneration apparatus
[62] Conduit
[64] Conduit
[66] Gas-liquid phase separator
[68] Conduit
[69] Conduit
[70] Conduit
[72] Conduit
[74] Compressor
[76] Conduit
[80] Flash stage
[81] Conduit
[82] Conduit
[83] Conduit
[85] Conduit
[90] CO oxidation catalyst

1. A process for producing a synthesis gas product stream containing hydrogen, carbon monoxide and carbon dioxide by steam reforming of a hydrocarbon-containing input stream with a reforming steam stream in a steam reformer, wherein the process comprises the steps of:
(a) providing a steam reformer comprising:
(a1) a multiplicity of steam reforming catalyst-filled reformer tubes having a means for introducing the hydrocarbon-containing input stream and the reforming steam stream into the reformer tubes and having a means for discharging a raw synthesis gas stream from the reformer tubes;
(a2) a reformer furnace having a floor, a ceiling and side walls forming a furnace interior, wherein the reformer tubes are arranged inside the furnace interior and are heated by a multiplicity of burners;
(a3) a flue gas conduit which is in fluid connection with the furnace interior through one of the side walls;
(b) providing the hydrocarbon-containing input stream and a reformer steam stream and introducing the hydrocarbon-containing input stream and the reformer steam stream into the reformer tubes;
(c) providing a fuel gas stream and an oxygen-containing oxidant stream and introducing the fuel gas stream and the oxygen-containing oxidant stream into the burners, burning the fuel gas stream with the oxygen-containing oxidant stream in the burners and thus heating the reformer tubes and producing a flue gas stream;
(d) reacting the hydrocarbon-containing input stream with the reforming steam stream under steam reforming conditions in the reformer tubes to afford the raw synthesis gas stream containing hydrogen, carbon monoxide, carbon dioxide, unconverted steam and unconverted hydrocarbons, discharging the raw synthesis gas stream from the reformer tubes and from the steam reformer;
(e) discharging the flue gas stream from the furnace interior through the flue gas conduit and introducing the flue gas stream or a treated flue gas stream into a flue gas chimney in fluid connection with the flue gas conduit;
(f) introducing the raw synthesis gas stream into a cooling apparatus, cooling the raw synthesis gas stream in the cooling apparatus, discharging a cooled raw synthesis gas stream from the cooling apparatus;
(g) introducing the cooled raw synthesis gas stream into an absorption column for separating carbon dioxide, contacting the cooled raw synthesis gas stream in the absorption column with an amine-containing scrubbing medium stream in countercurrent under conditions of chemisorptive gas scrubbing, discharging a carbon dioxide-depleted raw synthesis gas stream as a synthesis gas product stream from the absorption column, discharging a scrubbing medium stream enriched in carbon dioxide and carbon monoxide from the absorption column at the lower end;
(h) introducing the scrubbing medium stream enriched in carbon dioxide and carbon monoxide into a hot regeneration apparatus, hot regenerating the carbon dioxide-enriched partially regenerated scrubbing medium stream under hot regeneration conditions by stripping with intrinsic vapour and/or a stripping gas stream in the hot regeneration apparatus, discharging a hot-regenerated scrubbing medium stream from the hot regeneration apparatus, introducing at least a portion of the hot-regenerated scrubbing medium stream into the absorption column as an amine-containing scrubbing medium stream, discharging a carbon monoxide-containing carbon dioxide-rich gas stream from the hot regeneration apparatus;
(i) introducing at least a first portion of the carbon monoxide-containing carbon dioxide-rich gas stream
(i1) into the reformer furnace via at least one burner and/or
(i2) into the reformer furnace outside the burners and at a location in the reformer furnace at which the local gas temperature is at least 1000° C. and/or
(i3) into the flue gas conduit and/or
(i4) into the flue gas chimney;
(j) introducing a second portion of the carbon monoxide-containing carbon dioxide-rich gas stream into the reformer tubes.

2. The process of claim 1, wherein in the case of the alternative (i1) a feeding and distribution system for the carbon monoxide-containing carbon dioxide-rich gas stream which is separate from the operating gases of the burners and may be switched on or off or controlled separately is provided.

3. The process of claim 1, wherein in the case of the alternatives (i3) or (i4) a catalyst zone is provided in the flue gas conduit and/or in the flue gas chimney, wherein the catalyst zone contains a catalyst active for the catalytic oxidation of carbon monoxide with oxygen to afford carbon dioxide.

4. The process of claim 3, wherein the oxygen required for the catalytic oxidation of carbon monoxide is not separately introduced into the flue gas conduit or into the flue gas chimney but rather that exclusively the residual oxygen present in the flue gas stream is utilized as oxygen-containing oxidant.

5. The process of claim 3, wherein the catalyst zone contains at least one catalyst active for the catalytic oxidation of carbon monoxide with oxygen to afford carbon dioxide which is selected from the group consisting of:
catalyst beds composed of particulate catalysts, catalytic wire mesh, honeycomb catalysts, structured packing catalysts.

6. The process of claim 3, wherein the catalyst zone contains
(a) at least one catalyst active for the catalytic oxidation of carbon monoxide with oxygen to afford carbon dioxide which is also active for the selective catalytic reduction (SCR) of nitrogen oxides or
(b) at least one first catalyst active for the catalytic oxidation of carbon monoxide with oxygen to afford carbon dioxide and at least one second catalyst active for the selective catalytic reduction (SCR) of nitrogen oxides.

7. The process of claim 1, wherein no separate flash stage for separating a carbon monoxide-containing flash gas from the carbon dioxide-enriched scrubbing medium stream is present in the flow path of the carbon dioxide-enriched scrubbing medium stream between the absorption column and the hot regeneration apparatus.

8. The process of claim 1, wherein a third portion of the carbon monoxide-containing carbon dioxide-rich gas stream is discharged to the environment.

9. A plant for producing a synthesis gas containing hydrogen and carbon oxides by steam reforming of a hydrocarbon-containing input stream with a reforming steam stream in a steam reformer, wherein the plant comprises the following constituents and assemblies in fluid connection with one another:
(a) a steam reformer comprising:
(a1) a multiplicity of steam reforming catalyst-filled reformer tubes having a means for introducing the hydrocarbon-containing input stream and the reforming steam stream into the reformer tubes and having a means for discharging a raw synthesis gas stream from the reformer tubes;
(a2) a reformer furnace having a floor, a ceiling and side walls forming a furnace interior, wherein the reformer tubes are arranged inside the furnace interior and are heated by a multiplicity of burners;
(a3) a flue gas conduit which is in fluid connection with the furnace interior through one of the side walls;
(b) a means for providing the hydrocarbon-containing input stream and a reformer steam stream and a means for introducing the hydrocarbon-containing input stream and the reformer steam stream into the reformer tubes;
(c) a means for providing a fuel gas stream and an oxygen-containing oxidant stream and a means for introducing the fuel gas stream and the oxygen-containing oxidant stream into the burners;
(d) a means for discharging a raw synthesis gas stream containing hydrogen, carbon monoxide, carbon dioxide, unconverted steam and unconverted hydrocarbons from the reformer tubes and from the steam reformer;
(e) a flue gas chimney in fluid connection with the flue gas conduit, a means for discharging a flue gas stream from the furnace interior through the flue gas conduit and a means for introducing the flue gas stream or a treated flue gas stream into the flue gas chimney;
(f) a cooling apparatus, a means for introducing the raw synthesis gas stream into the cooling apparatus, a means for discharging a cooled raw synthesis gas stream from the cooling apparatus;
(g) an absorption column for separating carbon dioxide, a means for introducing the cooled raw synthesis gas stream into the absorption column at the lower end, a means for introducing an amine-containing scrubbing medium stream into the absorption column, a means for discharging a carbon dioxide-depleted raw synthesis gas stream as a synthesis gas product stream from the absorption column at the lower end, a means for discharging a scrubbing medium stream enriched in carbon dioxide and carbon monoxide from the absorption column at the lower end;
(h) a hot regeneration apparatus, a means for introducing the carbon dioxide-enriched scrubbing medium stream into the hot regeneration apparatus, a means for discharging a hot-regenerated scrubbing medium stream from the hot regeneration apparatus, a means for introducing at least a portion of the hot-regenerated scrubbing medium stream into the absorption column as an amine-containing scrubbing medium stream, a means for discharging a carbon monoxide-containing carbon dioxide-rich gas stream from the hot regeneration apparatus;
(i) a means for introducing at least one portion of the carbon monoxide-containing carbon dioxide-rich gas stream
(i1) into the reformer furnace via at least one burner and/or
(i2) into the reformer furnace outside the burners and at a location in the reformer furnace at which the local gas temperature is at least 1000° C. and/or
(i3) into the flue gas conduit and/or
(i4) into the flue gas chimney;
(j) a means for introducing a second portion of the carbon monoxide-containing carbon dioxide-rich gas stream into the reformer tubes.

10. The plant of claim 9, wherein in the case of the alternative (i1) it comprises a feeding and distribution system for the carbon monoxide-containing carbon dioxide-rich gas stream which is separate from the operating gases of the burners and may be switched on or off or controlled separately.

11. The plant of claim 9, wherein in the case of the alternatives (i3) or (i4) it comprises a catalyst zone in the flue gas conduit and/or in the flue gas chimney, wherein the catalyst zone contains a catalyst active for the catalytic oxidation of carbon monoxide with oxygen to afford carbon dioxide.

12. The plant of claim 11, wherein the catalyst zone contains at least one catalyst active for the catalytic oxidation of carbon monoxide with oxygen to afford carbon dioxide which is selected from the group consisting of:
catalyst beds composed of particulate catalysts, catalytic wire mesh, honeycomb catalysts, structured packing catalysts.

13. The plant of claim 11, wherein the catalyst zone contains
(a) at least one catalyst active for the catalytic oxidation of carbon monoxide with oxygen to afford carbon dioxide which is also active for the selective catalytic reduction (SCR) of nitrogen oxides or
(b) at least one first catalyst active for the catalytic oxidation of carbon monoxide with oxygen to afford carbon dioxide and at least one second catalyst active for the selective catalytic reduction (SCR) of nitrogen oxides.

14. The plant of claim 11, wherein no separate flash stage for separating a carbon monoxide-containing flash gas from the carbon dioxide-enriched scrubbing medium stream is present in the flow path of the carbon dioxide-enriched scrubbing medium stream between the absorption column and the hot regeneration apparatus.
